(19) United States
(12) Patent Application Publication
(10) Pub. No.: US 2010/0138146 A1
(43) Pub. Date: Jun. 3, 2010

(54) ROUTING METHOD, ROUTING ARRANGEMENT, CORRESPONDING COMPUTER PROGRAM, AND PROCESSOR-READABLE STORAGE MEDIUM

(76) Inventors: Wilhelm Vogt, Lichtenau (DE); Heiner Schepers, Hildesheim (DE); Axel Varchmin, Giesen (DE); Ulrich Kersken, Diekholzen (DE)

Correspondence Address: KENYON & KENYON LLP, ONE BROADWAY, NEW YORK, NY, 10004, US

(21) Appl. No.: 12/444,761

(22) PCT Filed: Oct. 12, 2007
(86) PCT No.: PCT/EP07/60860

§ 371 Date: Jan. 5, 2010

(30) Foreign Application Priority Data
Dec. 6, 2006 (DE) 10 2006 057 427.3

(51) Int. Cl. G01C 21/36

(52) U.S. Cl. 701/201; 701/200

(57) ABSTRACT

A routing method and an arrangement for executing such a method, as well as a corresponding computer program and a corresponding processor-readable storage medium, which can be used in particular in combination with a navigation system in order to provide a user (vehicle driver, or pedestrian, bicyclists, etc.) with comprehensive information relating to route planning, as well as corresponding decision possibilities. For this purpose, it is provided that motor vehicles using a vehicle navigation system are guided, maneuver recommendations and/or orientation recommendations being outputted for at least two driving routes by the vehicle navigation system, and that this is also provided for mobile non-vehicle systems.

### FIELD OF THE INVENTION

The present invention relates to a routing method and to an arrangement for carrying out such a method, as well as to a corresponding computer program and a corresponding processor-readable storage medium, capable of being used in particular in combination with a navigation system in order to provide a user of the routing method with comprehensive information relating to route planning, and with corresponding decision possibilities.

### BACKGROUND INFORMATION

Today's navigation systems, as described, for example, in U.S. Pat. No. 5,291,412 A, calculate the shortest, fastest, or “optimal” (as a rule, this is a mixture of these two criteria) route from the current vehicle position to the desired destination. In doing this, current traffic reports are taken into account, so that systems having a corresponding TMC (Traffic Message Channel) connection can circumvent traffic jams if the alternate route is more favorable. Before the trip, the driver decides the type of route he would prefer (fastest or shortest, or optimal). In every driving situation, he then receives exactly one optimal recommendation.

Even if, at an intersection, the driver theoretically has a plurality of near-equivalent possibilities, because for example the remaining trip time and the remaining distance to the destination are almost equal, it is always the case that the driver is given only one driving direction (or no recommendation is made if, for example, he is to continue driving straight ahead on the main road). The driver is not able to estimate how important it is to follow precisely this instruction. In many situations, it would be of interest to the driver to know that it would be possible for him to choose an alternative driving maneuver without great loss of time, such as for example if he is currently driving in the left lane and is supposed to turn right, but continuing straight ahead would also be a possible driving alternative.

In addition, navigation systems are also available for pedestrians, bicyclists, in-line skaters, and other participants in leisure-time sports. Such navigation systems are then as a rule installed on mobile devices such as personal digital assistants (PDAs), electronic travel guides, or mobile telephones. The disadvantages described in relation to conventional vehicle navigation also hold in principle for navigation systems for this group of users.

### SUMMARY

An object of the present invention is to provide a routing method and an arrangement for carrying out such a method, as well as a corresponding computer program and a corresponding processor-readable storage medium, that avoid the above-named disadvantages, and in particular provide information about alternative routes.

One advantage of the routing method according to an example embodiment of the present invention, using a navigation system or routing system, is that a user of the routing method is informed about alternative paths (=routes). This is achieved in that the navigation system additionally outputs at least one maneuver recommendation or orientation recommendation. Hereinafter, the term “maneuver recommendation” is used in the sense of “driving recommendation” and/or “orientation recommendation,” and thus also includes recommendations for walking, as well as for skating, and for movement and orientation for the indicated user groups and applications. Preferably, the maneuver recommendations are issued at a decision point at which the user must decide which path he would like to take at this path branching point or orientation point.

According to an example embodiment of the present invention, only those alternative routes are taken into consideration that differ at the current decision point in the course of the route. Here, the main path is the preferred route to the (main) destination—preferred in the sense that the calculated route to the destination best satisfies the specified criteria, or that the user has specified this route, or that the user is following a route proposed by the navigation system by following the driving instructions.

When using the example routing method according to the present invention in vehicles such as automobiles or motorcycles, but also bicycles, the knowledge of possible alternatives can also increase driving safety, because the vehicle driver can decide, on the basis of the traffic situation, which route he would like to follow; for example, he may prefer the alternative “continue straight ahead” to the alternative “turn right” if he is currently in the left driving lane and traffic is heavy. An analogous situation for pedestrians can occur for example if the pedestrian does not know how important it is to cross the street at precisely this moment (if the crossing light is red, or traffic in the street is heavy), or whether the alternative path, avoiding this light, can be taken without (great) loss of time. This increase in safety and/or convenience is achieved in that, as a function of specifiable criteria and their threshold values, driving instructions are outputted by the vehicle navigation system for more than one route.

Even a person familiar with the area may find it of interest to know that alternate paths can taken to the destination in almost the same time. He could then for example try out different routes, thus experiencing somewhat more variety in his routine trips, which in some circumstances can also result in a higher degree of attentiveness in traffic. For such a person, the question may also be of interest as to whether the optimal path is truly optimal, or whether a lower-rated route may in fact be better for him.

A preferred specific embodiment of the present invention provides that maneuver recommendations are outputted for at least one additional path to the same destination. Such maneuver recommendations (generally, at least two are made) include recommendations concerning at least two paths, for example one path that is optimal with respect to the specified routing criteria and/or options (also called the main path), and at least one path alternative thereto. Routing criteria or options are to be understood in general as all parameters that influence the character of the route, such as short, fast, low-risk, avoidance options, personal statistics, dynamization, comparative risk assessment, scenic routes, routes containing points of interest, etc.

In another specific embodiment, given the same destination, the same routing criteria and/or options are used as for the main path. The alternative path is then for example the second-shortest or second-fastest path. However, other evaluation criteria may also be used.

In another specific embodiment, given the same destination the maneuver recommendations relating to an alternative path are given using other routing criteria or options, for example with or without tolls, with or without TMC, shortest route, fastest route, optimal route, etc. That is, at least one alternative path is calculated, each using different routing criteria and/or options.

Advantageously, different weightings of driving maneuvers are specified for the calculation of alternative routes. Thus, for example it can be specified that in the calculation of the alternative paths U-turns be avoided, or that in the calculation of alternative paths the first part(s) of the street be avoided, in order for example to avoid having to go around the block as part of the main route. It may prove advantageous if the avoidance is a complete avoidance. Alternatively, an avoidance is achieved by assigning a lower or unfavorable evaluation to this part(s) of the street; for users such as pedestrians, in-line skaters, bicyclists, etc., off-road paths, squares, parks, stairs, etc., are also to be understood as “part of the street.”

It is also provided that maneuver recommendations be outputted in comparison to the reference path, calculated using a (permanently) prespecified reference setting.

Another preferred specific embodiment of the present invention provides that if the user has not selected a destination and at least one destination typical for that user (for example, a frequent destination) can be reached from the current position, at least one maneuver recommendation is outputted for the path to each user-typical destination that can be reached.

Another preferred specific embodiment of the present invention provides that maneuver recommendations are outputted for paths to various destinations, or to a group of destinations. Such destinations may for example include paths to (various)
towns,
parking facilities,
hotels,
sightseeing attractions/points of interest,
gas stations, and/or
restaurants.

These destinations are situated for example either along a route (for example points of interest, gas stations) or in the vicinity of a location (e.g., parking facilities, hotels), or in an area (e.g., a region or nature preserve), or are determined by the navigation system itself based on the current situation (e.g., gas stations, if the fuel level is low).

Typically, but not necessarily, a destination (for example the main destination), and thus the main route, is determined by the user. Additional destinations are determined;
either by the user, via one or more destination descriptions that determine individual destinations and/or a plurality of destinations, e.g., by selecting a category of points of interest, or
by the navigation system, via presets that are for example set in the equipment,
   or
by a third party (for example, a service provider such as Google, or via electronic data transmission, e.g., as a “promotional message”).
   or
additional destinations are supplied by an external auxiliary device (PND, PDA, notebook, data transmission unit, mobile radiotelephone device, . . . ),
   and at least one variable destination is selected by the navigation system. The selection can be narrowed down by the user by specifying for example the category.

In another specific embodiment, if the user has not selected a destination and at least two destinations typical for that user can be reached from the current position, maneuver recommendations are outputted for the paths to each user-typical destination that can be reached (for example, an intersection from which the route to the left leads toward Munich, and the route to the right leads toward Stuttgart). The user-typical destinations are for example destinations contained in the destination storage device or address book.

In general, the example routing method is installed on a mobile terminal device such as a mobile telephone, a personal digital assistant (PDA), a smart phone, or a personal navigation device (PND), and/or is integrated into a vehicle navigation system. Thus, the routing method can be used by a wide variety of users, such as automobile drivers, bicyclists, in-line skaters, and/or pedestrians. The maneuver recommendations are driving instructions for automobile drivers, or may be directions to the destination for pedestrians, bicyclists, in-line skaters, etc.

Moreover, additional path selection criteria may be used in the selection of the routes traveled. Thus, for motorcyclists, for example, winding paths may be exciting and can be classified as a scenic route, but only if the weather is dry. In case of rain, such a route should be avoided due to its risk. For drivers towing trailers or caravans, or truck drivers, turning maneuvers on narrow streets, as well as uphill and downhill inclines, represent a risk and are therefore to be avoided. For this reason, an exemplary specific embodiment of the present invention provides input (if no corresponding sensor mechanism is present) and evaluation possibilities for such selection criteria, such as path characteristics and/or weather conditions.

The points stated above in relation to vehicle navigation systems also hold generally for navigation systems used by pedestrians or other users moving at lower speed. On the other hand, it proves advantageous to take into account some features that are characteristic of this group of users in particular in the various specific embodiments.

A first such aspect is that in this user group the display or output of the route recommendations is less critical, because for example a pedestrian can easily come to a standstill. Therefore, a pedestrian can be given more information, because he does not have to simultaneously concentrate so strongly on traffic. Nonetheless, it would not make sense to overload the pedestrian with information, so that here as well alternative proposals should be made only if the alternatives do not entail significantly longer time durations or longer routes to be traveled. For example, instead of 5 km, which would be acceptable for a vehicle, here for example 300 meters would be acceptable; a percent portion of 5% likewise makes sense.

In a preferred specific embodiment of the routing method according to the present invention, it is provided that maneuver recommendations are outputted as a function of specifiable output criteria. In particular, it is advantageous here if, before outputting the maneuver recommendation, the time required to travel the route, and/or its length, are evaluated as output criteria. The output criteria are evaluated as the difference and/or quotient relative to the main route or to the reference route. It is especially advantageous if threshold values are specified for the output criteria. These threshold values can be specified e.g., relative to the route length and/or driving time or walking time, and/or absolutely. Advantageously, the result of the evaluation is presented with reference to the maneuver recommendations, e.g., the time difference and/or path difference of the maneuver recommendation relative to the main route.

In another preferred specific embodiment of the routing method according to the present invention, it is additionally provided that, at specifiable intersections, for a specifiable number of exits (i.e., alternative routes to be driven or walked), the time required to travel the rest of the route (remaining time) and/or the remaining route length are outputted. Alternatively, however, for intersections having three or more exits the remaining (driving) times and/or (driving) route lengths for the (driving) routes having the two, or three, or even more, best evaluations may be outputted. The specifications of the intersections at which vehicle drivers are provided with driving instructions concerning alternative routes may provide that remaining driving times and/or driving route lengths for alternative routes are outputted at intersections from which
at least one highway and/or
at least one rural road
   branches off.

In another preferred specific embodiment of the routing method according to the present invention, it is provided that information concerning the maneuver recommendations, and/or the maneuver recommendations themselves, are outputted as a function of route criteria and/or route options, i.e., for example as a function of the presence of tolls, traffic disturbances, tunnels, bridges, points of danger, scenic attractions, etc. Preferably, these items of information are displayed in the form of symbols and/or icons related to the maneuver recommendation. For example, if there is a traffic disturbance or a tunnel located along the main route, a maneuver recommendation is then preferably outputted concerning an alternative route not having a traffic disturbance or not having a tunnel, and an icon indicating a traffic disturbance or a tunnel symbol, relating to the maneuver recommendation on the main route, is for example displayed or outputted acoustically (e.g., “Warning: the main route contains a traffic disturbance/a tunnel”).

A preferred specific embodiment of the routing method according to the present invention provides that the threshold values of the criteria and/or the routing criteria or options that are to be taken into account can be modified and/or can be selected by user input.

Another preferred specific embodiment of the routing method according to the present invention provides that the sequence of the outputting of the maneuver recommendations and/or the preferred representation is determined by the evaluation of the paths.

Another preferred specific embodiment of the routing method according to the present invention provides that navigational or maneuver recommendations are outputted acoustically and/or visually. For example, maneuver recommendations may be made acoustically for one path, and visually for a plurality of paths. In the case of visual display, it is particularly advantageous if the maneuver recommendations are displayed in a different form, with different colors, different levels of gray, and/or different levels of brightness, as a function of their evaluation. This is advantageous in particular for automobile drivers, because the outputting of the driving instructions with corresponding emphases makes it easy for the driver to assess the situation at a glance, so that his attention is diverted as little as possible from the momentary traffic situation.

In another specific embodiment, attention is called to the fact that particular maneuvers require a large detour and/or loss of time, so that, in contrast to equivalent alternatives, these can be purposely avoided by the user—in essence, “negative” maneuver recommendations are made.

An example arrangement for executing a routing method according to the present invention has at least one chip and/or processor, and is combined with a navigation system, and is set up in such a way that the navigation system outputs maneuver recommendations for at least two routes.

A preferred specific embodiment of the arrangement according to the present invention provides that the arrangement includes a mobile terminal device, such as a mobile telephone, a personal digital assistant (PDA), smart phone, or personal navigation device (PND) or the like. This makes it possible in particular for pedestrians, bicyclists, or other users who do not standardly use a navigation device, to make use of the present invention.

Another preferred specific embodiment of the arrangement according to the present invention provides that the arrangement is combined with a vehicle navigation system.

A computer program according to the present invention makes it possible for a data processing device to execute a routing method (after said program has been loaded into the memory of the data processing device) using a navigation system, such that maneuver recommendations are outputted by the navigation system for at least two routes.

Such computer programs may for example be available for downloading (for a fee or free of charge, freely accessible or password-protected) in a data network or communication network. The computer programs provided in this way can then be made usable by an example method in which a computer program is downloaded from an electronic data network, such as the Internet, onto a data processing device that is connected to the data network.

In order to provide maneuver recommendations to pedestrians or in-line skaters according to the present invention, or to guide a motor vehicle in accordance with the present invention, it is provided to use a processor-readable storage medium on which a program is stored that enables a data processing device (after the program has been loaded into the memory of the data processing device) to carry out a routing method using a navigation system, such that maneuver recommendations are outputted by the navigation system for at least two routes.

A particular advantage of the present invention is the (almost) simultaneous offering of a plurality of driving instructions having almost equal ratings. For example, acoustically the better instruction is emitted first; optically, both recommendations are displayed simultaneously.

### BRIEF DESCRIPTION OF THE DRAWINGS

In the following, the present invention is explained in more detail in relation to various exemplary embodiments, on the basis of the FIGURE.

FIG. 1 shows illustrations of possibilities for the optical output of driving instructions for a plurality of driving routes.

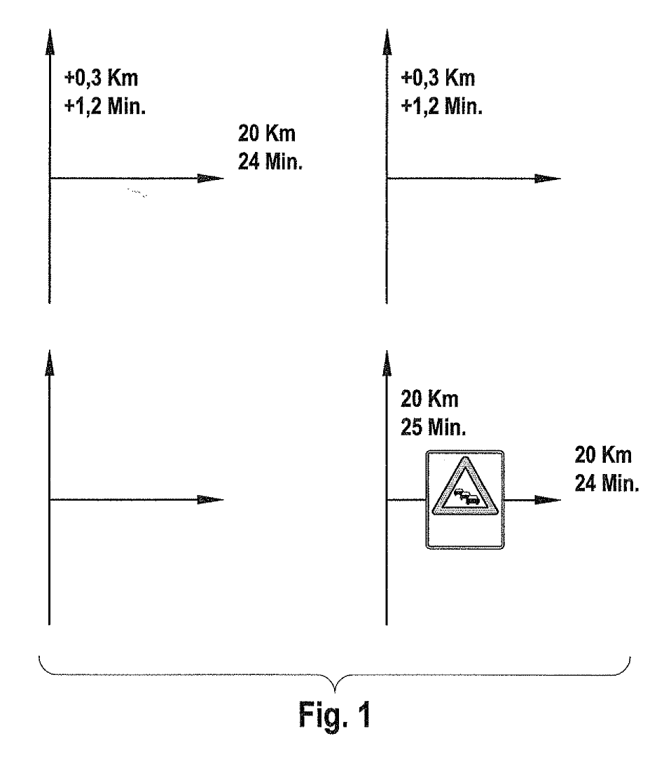

### DETAILED DESCRIPTION OF EXAMPLE EMBODIMENTS

In the following, the present invention is explained on the basis of various practical examples. For example, the use of the present invention is described in relation to vehicle navigation systems, i.e., navigation systems integrated into a passenger vehicle, truck, motorcycle, or the like. In addition, aspects of exemplary specific embodiments in the use of the present invention in navigation systems for pedestrians, bicyclists, in-line skaters, leisure-time sports enthusiasts, or the like, are described in greater detail.

The examples relate to turn-by-turn presentations, but may be transferred analogously to 2D or 3D representations; i.e., a representation may be shown at an arbitrary scale on the two-dimensional or three-dimensional map, so that the vehicle driver is given a larger overview of the various path routings. This may include for example 3D representations of the pictograms showing the route, or a video image/satellite image/animation/simulation/photograph.

In order to realize an exemplary arrangement according to the present invention, a navigation system such as is commercially available today may be sufficient. The following alternatives may be provided for the optical and/or acoustic outputting of the maneuver recommendations and/or orientation recommendations:
1) At decision points, e.g., at intersections, for the possible exits the remaining driving times and/or distances to the destination are indicated (optically and/or acoustically), and/or important differences in the paths (e.g., traffic disturbances) are indicated as icons. (Shown in the FIGURE.)
2) In order to avoid overloading the driver with information, time and/or distance are not outputted, or are outputted only for some of the exits. Instead of outputting time and/or distance, a ranking of the driving routes is determined by an evaluation, and is indicated for example optically by color identification (dark routes are to be preferred; bright ones are worse; saturated colors are preferred; less favorable routes are shown more transparently). Depending on the color value, the driver then sees at a glance which possibilities are worthy of consideration. Alternatively, the display may also use colors, line thicknesses, continuous/broken-line representation, etc. The representation is made in the display device of the navigation system and/or in a head-up display.
3) In another development, a particular identifier is used for the optimal route, the shortest route, and the fastest route; for example, the same color may be used for each of these.
4) Another development uses the volume or sequence of instructions in a manner analogous to the visual representation.
5) At the decision points, the remaining driving times and/or distances to the destination are indicated only for the two “most optimal” exits. In a further stage, the items of information may be provided for all “equivalent” exits; i.e., under some circumstances this may be more than two.
6) Another alternative form of output provides the representations indicated above. Instructions are outputted concerning alternative driving routes, but only at decision points at which the remaining driving times and distances are close to one another. Otherwise, only one unambiguous recommendation is made, as was previously standard. In this case, suitable thresholds are defined for the time and/or distance differences; for example 2 minutes or 2 km. However, the threshold may also (possibly in addition) be a function of the remaining path; for example, a driver may be prepared to drive 500 km instead of 495 km, but will presumably not be prepared to drive 10 km instead of 5 km. A specific embodiment provides that the route length and route time be taken into account: maximum time difference=minimum (10% remaining minutes, 5 minutes); maximum distance difference=minimum (10% remaining kilometers, 5 km). A preferred exemplary specific embodiment provides that the driver can influence the setting of these thresholds (preferably within certain limits), or can completely switch off this function. This does not automatically take place for the thresholds (0, 0), that is, when the driving time and length for two different driving routes do not differ, because it is theoretically possible that two paths may actually be completely equivalent in their evaluation. In addition to the above-named thresholds, for certain route options thresholds are also defined, such as for example no tunnel/tunnel shorter than 1 km, or no toll/toll less than 2 Euros.
7) In a specific embodiment, U-turns on the alternative routes are avoided, so that these routes do not lead immediately back to the best route.
8) In another specific embodiment, the first section or sections of roadway along the best route are blocked for the alternative routes, so that in the near-field a certain detour is actually traveled.
9) In another exemplary specific embodiment, it is provided that, in the case of an acoustic output, the sequence and/or volume of the instructions enable a distinction to be made between an optimal and a suboptimal instruction. Preferably, a visual outputting of information concerning alternative driving routes is made in parallel fashion. Another exemplary specific embodiment provides that only one driving instruction be given acoustically, but that a filler word or some other phrase of speech, pitch, gong sound or tone, voice, or the like be used to indicate that there is at least one alternative having a similar evaluation. This can then be viewed optically by the driver on the display as needed.

In an exemplary specific embodiment of the present invention, the routes corresponding to various criteria and/or options (shortest, fastest, optimal, most interesting, most scenic, lowest-risk) are distinguished by means of color.

A specific embodiment of the present invention is not limited to the preferred exemplary embodiments indicated in the foregoing. Rather, a number of variants are possible that make use of the arrangement according to the present invention and of the routing method according to the present invention in embodiments that are fundamentally different in their realization. In particular, arbitrary combinations of the above-described exemplary embodiments are possible.

1-30. (canceled)

31. A routing method using a navigation system or routing system, comprising:
outputting, by the navigation system or routing system, a maneuver or orientation recommendation; and
outputting, by the navigation system or routing system, at least one additional maneuver or orientation recommendation.

32. The routing method as recited in claim 31, wherein the at least one additional maneuver or orientation recommendation includes a route, alternative to a main route, to a same destination.

33. The routing method as recited in claim 32, wherein for at least one alternative route, a same routing criteria or routing options are used as for the main route.

34. The routing method as recited in claim 33, wherein the alternative route is at least one of a shortest or second fastest route.

35. The routing method as recited in claim 32, wherein for at least one alternative route, at least one of other routing criteria and routing options are used than are used for the main route.

36. The routing method as recited in claim 35, wherein the main route is selected taking traffic information into account, and the alternative route is selected not taking traffic information into account.

37. The routing method as recited in claim 35, wherein the main route is a fastest route and the alternative route is a second fastest route.

38. The routing method as recited in claim 32, wherein for at least one alternative route, a weighting is used for driving maneuvers to avoid U-turns or to avoid driving around a block.

39. The routing method as recited in claim 32, wherein the at least one additional maneuver or orientation recommendation is outputted for at least one route having at least one destination differing from the main route if points of interest are situated close to the route or in a vicinity of the route.

40. The routing method as recited in claim 31, wherein one or more of the destinations are defined by the user via a destination description that describes at least one destination.

41. The routing method as recited in claim 40, wherein the destination description includes one of:
i) parking facilities in a vicinity of the main destination defined by the user;
ii) hotels in the vicinity of the main destination;
iii) points of interest along a route;
iv) gas stations along a route; and
v) restaurants along a route.

42. The routing method as recited in claim 40, wherein one or more destinations are at least one variable destination selected by at least one of: the navigation system, a third party, and an external terminal device.

43. The routing method as recited in claim 40, wherein the one or more destinations are a group of destinations.

44. The routing method as recited in claim 43, wherein the group of destinations can be newly selected at any time during the course of a trip.

45. The routing method as recited in claim 43, wherein the group of destinations is one of:
i) parking facilities in a vicinity of a destination defined by the a user;
ii) points of interest along a route;
iii) gas stations; and
iv) service stations.

46. The routing method as recited in claim 32, wherein if the user has not selected a destination and a plurality of user-typical destinations can be reached from the current position, maneuver or orientation recommendations are given for routes to each of the destinations that can be reached.

47. The routing method as recited in claim 31, wherein the additional maneuver or orientation recommendations are outputted acoustically or visually.

48. The routing method as recited in claim 47, wherein the additional maneuver or orientation recommendations are outputted together via a same display device.

49. The routing method as recited in claim 47, wherein the additional maneuver or orientation recommendations are output acoustically one after another.

50. The routing method as recited in claim 47, wherein acoustic maneuver or orientation recommendations are made only for a main route, and visual maneuver or orientation recommendations are outputted for a plurality of routes.

51. The routing method as recited in claim 47, wherein more than one acoustic maneuver or orientation recommendation is made, a preferred maneuver recommendation being emphasized by the sequence of the outputting.

52. The routing method as recited in claim 51, wherein the preferred maneuver recommendations is made first.

53. The routing method as recited in claim 47, wherein more than one acoustic maneuver or orientation recommendation is made, a preferred maneuver recommendation being emphasized at least one of using filler words by volume, by choice of voice, by pitch, or by a previous acoustic signal.

54. The routing method as recited in claim 51, wherein the sequence of the outputting of the maneuver or orientation recommendations is determined by an evaluation of a respectively associated route.

55. The routing method as recited in claim 51, wherein after repeated following of maneuver or orientation recommendations for a route, an output is selected so that a way that maneuver or orientation recommendations relating to the preferred route are also outputted in preferred fashion.

56. The routing method as recited in claim 31, wherein the additional maneuver or orientation recommendations are outputted only if they satisfy the threshold values.

57. The routing method as recited in claim 31, wherein the additional maneuver or orientation recommendations are output only if they contain prespecifiable output criteria.

58. The routing method as recited in claim 57, wherein the output criteria are determined relatively or absolutely to the routing criteria and routing options of a main route.

59. The routing method as recited in claim 57, wherein the output criteria are limited by a maximum number of additional maneuver or orientation recommendations.

60. The routing method as recited in claim 57, wherein the output criteria are determined in relatively or absolutely, in relation to at least one of a route length and a time required.

61. The routing method as recited in claim 57, wherein the output criteria is prespecified by user input.

62. The routing method as recited in claim 61, wherein the output criteria can be modified by user input.

63. The routing method as recited in claim 31, wherein the additional maneuver or orientation recommendations of the alternative routes are represented visually, differences from a main route being visualized.

64. The routing method as recited in claim 63, wherein the differences are visualized as a driving time difference or as a symbol.

65. The routing method as recited in claim 31, wherein the maneuver or orientation recommendations and the additional maneuver or orientation recommendations are output visually in a different form from one another, using at least one of different colors, different gray levels, or different brightness levels.

66. The routing method as recited in claim 65, wherein the different form is created as a function of user preference.

67. The routing method as recited in claim 31, wherein the maneuver or orientation recommendations, and the additional maneuver or orientation recommendations represent different routes and are output visually, and at least one of: i) prespecifiable features of the routes being output as a pictogram, ii) routes are shown in a map, or iii) important points are output in a zoomed representation.

68. The routing method as recited in claim 31, wherein the maneuver or orientation recommendations and the additional maneuver or orientation recommendations represent different routes, the various routes, and the associated maneuver or orientation recommendations being represented in a map, or are represented separately in a split-screen display.

69. The routing method as recited in claim 31, wherein “negative” maneuver or orientation recommendations are given by indicating that particular maneuvers entail at least one of: i) going significantly out of the way, ii) a loss of time, or iii) a large degree of risk, and should be avoided by the user.

70. The routing method as recited in claim 31, wherein only one maneuver or orientation recommendation is made acoustically, the recommendation being made using a filler word, a different phrase of speech, pitch, gong/tone, or voice to indicate that there exists at least one alternative maneuver recommendation having a similar evaluative rating.

71. An arrangement for executing a routing method, the arrangement comprising at least one chip or processor, and the arrangement being combined with a navigation system, wherein the arrangement is set up in such a way that a plurality of maneuver or orientation recommendations are output together by the navigation system.

72. A storage medium storing a computer program that, when executed by a processor of a navigation system, enables the navigation system to output maneuver or orientation recommendations and additional maneuver or orientation recommendations.

73. A processor-readable storage medium on which a program is stored that, when executed by a processor of a navigation system, enables the navigation system to output maneuver or orientation recommendations and additional maneuver or orientation recommendations.

74. A routing method, comprising:
downloading a navigation program from a network, and using the navigation program to output maneuver or orientation recommendations, and additional maneuver or orientation recommendations.
